(19) United States
(12) Patent Application Publication
(10) Pub. No.: US 2025/0149807 A1
(43) Pub. Date: May 8, 2025

(54) ELECTRICAL UNIT HAVING AN ELECTRICAL MODULE ARRANGED ON A COVER PLATE OR A COVER PLATE ASSEMBLY, AND METHOD OF MOUNTING THE COVER PLATE OR THE COVER PLATE ASSEMBLY

(71) Applicant: HELLA GMBH & CO. KGAA, Lippstadt (DE)

(72) Inventors: Udo Gottschling, Iserlohn (DE); Thomas Hilsenbeck, Erwitte-Stirpe (DE); Tilman Maucher, Lippstadt (DE)

(21) Appl. No.: 18/925,269

(22) Filed: Oct. 24, 2024

(30) Foreign Application Priority Data
Nov. 2, 2023 (DE) 102023130229.9

(51) Int. Cl. H01R 4/04; H01R 4/02; H05B 3/84

(52) U.S. Cl. CPC H01R 4/04; H05B 3/84; H01R 4/02; H05B 2203/016; H05B 2214/02

(57) ABSTRACT

The present invention relates to an electrical unit, in particular a lighting device or a sensor device of a motor vehicle, having a cover plate or a cover plate assembly. At least one electrical module is arranged on the cover plate or the cover plate assembly, in particular a heating module, a light module or a sensor module. The electrical module is operable by a separate control unit. A housing of the unit has at least two pockets into which electrical contacts of the control unit enter. The cover plate or the cover plate assembly has at least two pins on which electrical contacts of the electrical module are arranged, wherein the pins project into the pockets and are connected thereto by an electrically conductive joining means in a substance-to-substance bonding manner in such a way that an electrical connection is formed between the electrical module and the control unit.

### CROSS-REFERENCE TO RELATED APPLICATIONS

The present application claims the benefit of German Patent Application No. 10-2023-130-229.9, filed Nov. 2, 2023, the disclosure of which is incorporated by reference.

### FIELD OF THE INVENTION

The present invention relates to an electrical unit, in particular a lighting device or a sensor device of a motor vehicle, having an electrical module arranged on a cover plate or a cover plate assembly, in particular a heating module, a light module or a sensor module, as well as a method for mounting the cover plate or the cover plate assembly onto the unit.

### BACKGROUND OF THE INVENTION

Various electrical units are equipped with heatable cover plates to protect them from icing or condensation during practical use, and in particular to ensure unrestricted permeability of the cover plates for electromagnetic radiation, such as light or radio waves. Application examples from the field of automotive engineering include headlights as well as radar and lidar sensors.

For example, heating modules are known that comprise heating wires arranged on the cover plates, whose Joule heat is used for heating. The connection to an associated control unit as a power source for operating the heating modules is usually realized by means of a plug connection or spring contacts. A group of lines coming from the control unit is connected to the cover plate by means of a central plug and brought into contact with the heating module.

In addition to heating modules, this connection concept can also be applied to other electrical modules. For example, in the field of automotive engineering, sensor modules or light modules, such as for a daytime running light function, can be arranged on a cover plate or on a support or cover frame that forms an assembly with it. To operate this type of electrical module, an electrical plug connection is established to a separate control unit, which is typically located inside the unit.

In practice, this connection concept has the disadvantage that the connector can become loose due to vibrations or shocks, which reduces the effective contact surface or can result in a complete loss of contact. Subsequently, corrosion can occur on exposed portions of individual contact pins and local burn-off can occur due to the high contact resistance. Furthermore, lighting device for motor vehicles nowadays has to meet high design and aesthetic requirements, and a connector that is visible from the outside behind the cover plate must be regarded as disadvantageous from this point of view, or at least as an undesirable restriction of design freedom. In addition, the connection concept involves a disadvantageously high level of effort with regard to installation, as attaching the connector to the cover plate is a process that can hardly be automated and is usually carried out manually in practice, for example in the series production of lighting device for motor vehicles.

### SUMMARY OF THE INVENTION

It is the object of the present invention to propose an embodiment of an electrical unit having an electrical module arranged on the cover plate or a cover plate assembly, which overcomes the aforementioned disadvantages of the prior art and is suitable in particular for lighting devices or a sensor device of a motor vehicle. This object is achieved on the basis of an electrical unit and a related method.

The technical teaching of the invention discloses an electrical unit having a cover plate or a cover plate assembly, wherein at least one electrical module is arranged on the cover plate or the cover plate assembly, in particular a heating module, a light module or a sensor module, wherein the electrical module is operable by means of a separate control unit, and according to the invention a housing of the unit has at least two pockets into which electrical contact means of the control unit enter, wherein the cover plate or the cover plate assembly has at least two pins on which electrical contact means of the electrical module are arranged, wherein the pins project into the pockets and are connected thereto in a substance-to-substance bond by means of an electrically conductive joining means, such that an electrical connection is formed between the electrical module and the control unit.

The invention is based on the idea of replacing the connector commonly used in the prior art with an electrically conductive joining means into which electrical contact means of the electrical module and the control unit designed to operate it enter. The electrical conductivity of the joining means is so high that no significant ohmic losses occur when electrical current is passed between the contact means. Each of the at least two connections formed in this manner is intended for one electrical polarity, i.e. for supplying the electrical module on the anode or cathode side. If the unit comprises several electrical modules arranged on the cover plate or the cover plate assembly, a suitable number of pockets and pins must be provided for the associated electrical contact means. A cover plate assembly is formed by a cover plate and at least one other component connected to it, for example a support frame or cover frame for the electrical module. The cover plate assembly is characterized in particular by the fact that it can be handled as a coherent unit when installed on the housing of the electrical unit.

The connection concept according to the invention is designed to compensate for manufacturing tolerances of the cover plate or the cover plate assembly and the housing in such a manner that the pockets on the housing side have a larger diameter than the pins of the cover plate or the cover plate assembly accommodated therein. The pins are used to insert the electrical contact means of the electrical module arranged on them into the electrically conductive joining means, which fills the pockets and covers the electrical contact means of the control unit that enter into the pockets. The joining means is transferred to a hardened state after the cover plate or cover plate assembly has been installed, so that the connection between the contact means is permanent and non-detachable and, in particular, cannot be impaired by vibrations or shocks that occur during practical operation of the unit.

In particular, the separate control unit is accommodated in the interior of the electrical unit formed between the cover plate and the housing. The pockets are preferably formed in the background of the housing, and the electrical contact means of the electrical module and the control unit can extend into the pockets in such a manner that they are not visible to an observer from the outside through the cover plate.

The joining means is formed in particular as an electrically conductive adhesive or solder. For example, acrylate-, epoxy-, polyurethane- or silicone-based adhesives or sealants are known that are doped with metallic pigments or fillers and have a suitable electrical conductivity. Low-melting alloys are particularly suitable as solders, as they do not cause thermal damage to the pockets of the housing and pins of the cover plate, which are typically made of plastic. In the hardened state, the required electrical connection between the electrical contact means of the electrical module and the control unit is provided by both adhesive and solder. In addition, it is also advantageous to form mechanically resilient, substance-to-substance connections between the pins and the pockets.

In an advantageous embodiment of the electrical unit, the electrical module is designed as a heating module in the form of a heating foil. Said heating foil comprises a two-dimensional arrangement of one or more fine heating wires that are accommodated on or in a carrier foil, for example by means of back injection molding. The heating foil is arranged on the inside of the cover plate, in particular glued on, and the electrical contact means preferably branch off from the heating foil in the immediate vicinity of the pins of the cover plate.

The electrical contact means of the electrical module and/or the control unit are formed in particular by line ends with exposed strands, contact lugs or similar. The line ends are enclosed by the electrically conductive joining means and the associated electrical lines are connected to the electrical module or the control unit.

In a further advantageous embodiment, the electrical contact means of the control unit are latched or clamped to the pockets, for example by means of barb-like latching lugs that are hooked into corresponding receptacles in the wall of the pockets. This means that the contact means are already fixed in the pockets during assembly, so that the desired coverage with the joining means filled into the pockets is ensured.

For example, the electrical contact means of the electrical module have metallic sleeves that are plugged onto the pins and/or the electrical contact means of the control unit have metallic inserts that are pressed into the pockets. The electrical supply lines are connected to the sleeves or inserts using crimp connections, for example. In this embodiment, there is a contact resistance between the electrical contact means and the joining means that has a particularly large area and therefore a low resistance.

In a further embodiment, the electrical contact means of the electrical module and the control unit are in direct physical contact, wherein the contact is secured by the joining means. For example, the contact means of the control unit have spring-like inserts at the end of the line, which form a preloaded physical contact with the sleeves of the electrical contact means of the electrical module that are plugged onto the pins. Due to the at least partial embedding by the electrically conductive joining means, this contact arrangement is secured in such a manner that a low-resistance contact resistance is guaranteed even if the position of the contact means changes due to vibration.

The electrical unit according to the invention is designed in particular as a component for a motor vehicle, for example as a headlight, a rear light or a radar or lidar sensor. The housings and cover plates are injection-molded plastic components in particular.

In a further embodiment, the electrical module is arranged on a support frame or a cover frame, wherein the support frame or the cover frame forms part of the cover plate assembly. In particular, the respective frame is formed in one piece with the cover plate, for example in the course of production by injection molding. Alternatively, the frame may have been joined to the cover plate in a separate manufacturing step so that the cover plate assembly is formed, on which the electrical module is accommodated.

The invention also relates to a method for installing the cover plate or the cover plate assembly on an electrical unit according to one of the aforementioned embodiments, wherein at least the following steps are carried out in an undefined order:
providing the cover plate or the cover plate assembly with the at least one electrical module arranged thereon, wherein the cover plate or the cover plate assembly has the at least two pins on which the electrical contact means of the electrical module are arranged, and wherein the cover plate has at least one joining web,
providing the unit with the control unit for operating the electrical module and with the housing, which has at least one joining bed and the at least two pockets into which the electrical contact means of the control unit enter,
filling the electrically conductive joining means into the pockets, wherein the electrical contact means of the control unit entering into the pockets are covered with the joining means,
filling an adhesive into the joining bed,
positioning the cover plate or the cover plate assembly on the housing in such a manner that the pins and the electrical contact means of the electrical module arranged thereon are immersed in the joining means in the pockets, and that the joining web is immersed in the adhesive in the joining bed, and
curing of the joining means and/or the adhesive.

The electrical connection between the electrical module and the control unit is thus established in conjunction with the load-bearing connection of the cover plate to the housing via an adhesive connection. This is realized via a substance-to-substance connection between the adhesive-filled joining bed and the joining web immersed therein. The electrically conductive joining means and the adhesive are each filled into the pockets or the joining bed in a flowable state. When positioning the cover plate or the cover plate assembly, manufacturing tolerances can be compensated for both in the joining bed and in the pockets, which are dimensioned in such a manner that sufficient clearance is available for the detailed positioning of the joining web or the pins.

During installation, the control unit forms an assembly with the housing and the electrical module forms an assembly with the cover plate or the cover plate assembly, i.e. the electrical module is positioned together with the cover plate or the cover plate assembly relative to the housing.

Depending on the type of adhesive, the adhesive in the joining bed and any electrically conductive adhesive used as a joining means in the pockets can be cured by means of heating, for example by high-frequency excitation, or UV irradiation. The adhesives used can, for example, be designed as 2-component systems or as 1-component systems that crosslink using moisture. When using a solder as a joining means, it is only required to wait for it to solidify. Furthermore, an electrically conductive paste without a solidification process can be used as a joining means. The adhesive applied to the joining bed can, for example, be formed permanently elastic so that it does not harden.

These and other features and advantages of the present invention will become apparent from the following description of the invention. Before the embodiments of the invention are explained in detail, it is to be understood that the invention is not limited to the details of operation set forth in the following description. The invention may be implemented in various other embodiments and of being practiced or being carried out in alternative ways not expressly disclosed herein. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

Further measures improving the invention are described below together with reference to the figures. In the figures:

FIG. 1a shows a first cross-sectional view of a first exemplary embodiment;

FIG. 1b shows a second cross-sectional view of section line A-A of FIG. 1a;

FIG. 2a shows a first cross-sectional view of a second exemplary embodiment;

FIG. 2b shows a second cross-sectional view of section line B-B of FIG. 2a;

FIG. 3 shows a cross-sectional view of a third exemplary embodiment;

FIG. 4 shows a cross-sectional view of a fourth exemplary embodiment;

FIG. 5 shows a cross-sectional view of a fifth exemplary embodiment, and

FIG. 6 shows a detailed view of a latched contact means.

### DETAILED DESCRIPTION OF THE CURRENT EMBODIMENTS

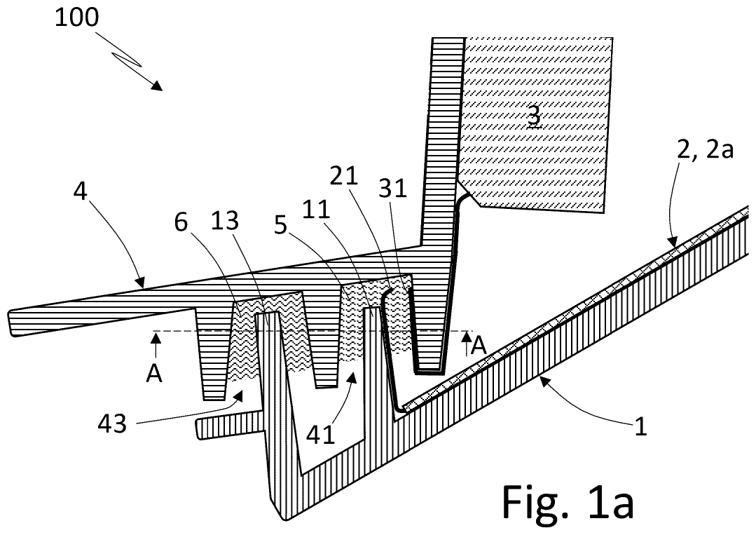

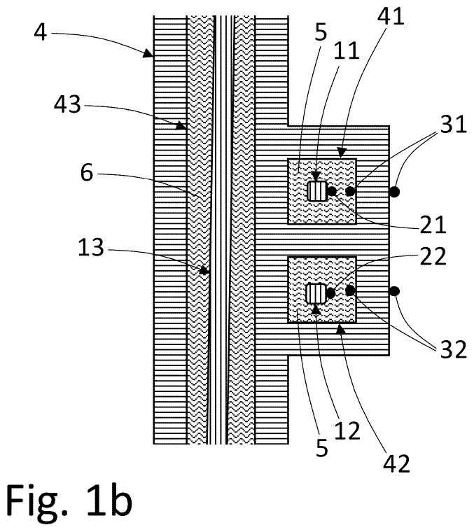

FIG. 1a shows a part of a first exemplary embodiment of the electrical unit 100 according to the invention in cross-sectional view, and FIG. 1b shows a further cross-sectional view along the section line A-A in FIG. 1a. Only the section surfaces are depicted in all figures.

The electrical unit 100 comprises a heatable cover plate 1 with the electrical module 2 arranged on it in the form of a heating module 2a, which is operable by means of the control unit 3 accommodated inside the unit 100. The heating module 2a is designed as a heating foil that is glued to the inside of the cover plate.

The electrical connection between the heating module 2a and the control unit 3 is formed in that the housing 4 has the two pockets 41, 42, into which the electrical contact means 31, 32 of the control unit 3 enter, wherein the cover plate 1 has the two pins 11, 12, on which the electrical contact means 21, 22 of the heating module 2a are arranged, wherein the pins 11, 12 project into the pockets 41, 42 and are connected to these by means of the electrically conductive joining means 5. For example, the cathode-side connection is established via pocket 41 and the anode-side connection via pocket 42. The joining means 5 has a suitably high electrical conductivity, so that an electrical current can be passed with low loss between the line ends of the contact means 11 and 31 or 12 and 32 that enter into it.

The pockets 41, 42 have a significantly larger diameter than the pins 11, 12, so that dimensional deviations of the cover plate 1 or the housing 4 due to the manufacturing process can be compensated for during the establishment of the connection.

Furthermore, the housing 4 comprises the channel-shaped joining bed 43, which is filled with the adhesive 6, and the cover plate 1 has the projecting joining web 13, which is enclosed at the end by the adhesive 6. The adhesive connection formed in this manner is used for mechanically resilient and largely media-tight accommodation of the cover plate 1 on the housing 4 of the electrical unit 100.

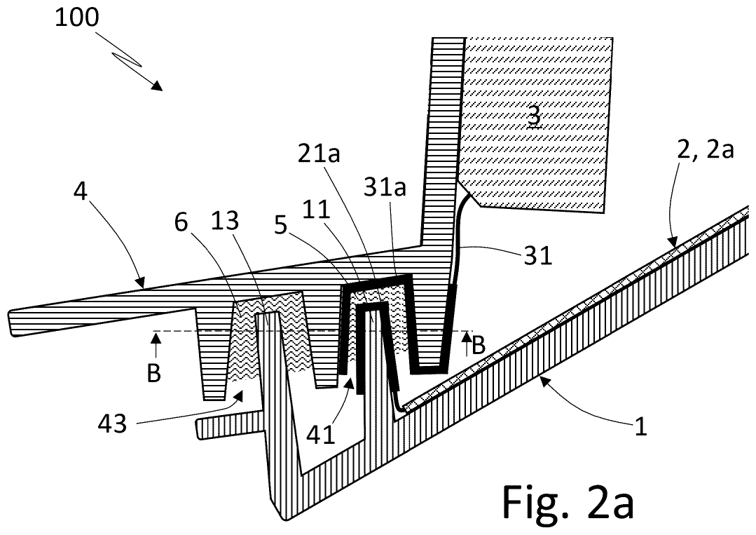

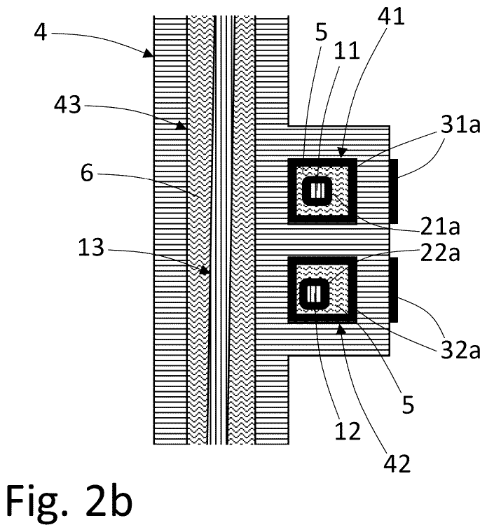

FIG. 2a shows a part of a second exemplary embodiment of the electrical unit 100 according to the invention in cross-sectional view, and FIG. 2b shows a further cross-sectional view along the section line A-A in FIG. 2a.

In contrast to the first exemplary embodiment, the electrical contact means 21, 22 of the electrical module 2 have the metallic sleeves 21a, 22a, which are plugged onto the pins 11, 12, and the electrical contact means 31, 32 of the control unit 3 have the metallic inserts 31a, 32a, which are pressed into the pockets 41, 42.

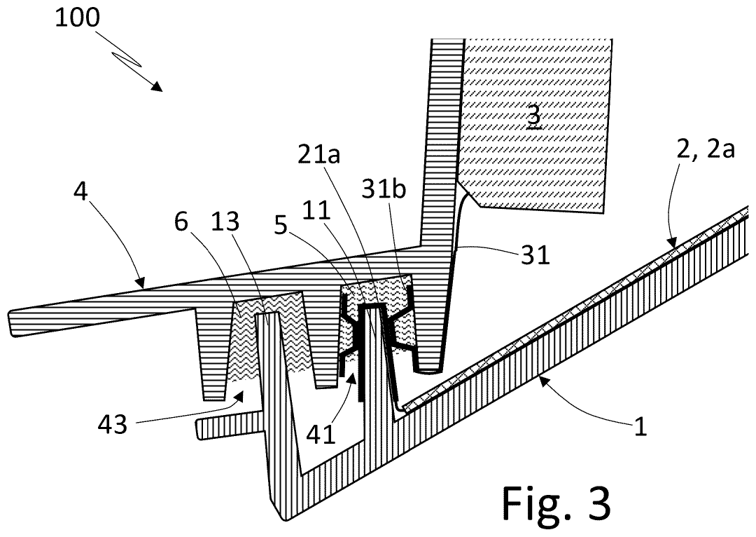

FIG. 3 shows a part of a third exemplary embodiment of the electrical unit 100 according to the invention in cross-sectional view. The electrical contact means 21, 31 of the electrical module 2 and the control unit 3 are in direct physical contact, wherein the contact is secured by the joining means 5. As an example, the contact means 31 of the control unit 3 has the spring-like insert 31b at the end of the line, into which the pin 11 was pressed during installation, so that a prestressed physical contact is formed with the sleeve 21a of the electrical contact means 21 of the electrical module 2, which is plugged onto the pin 11.

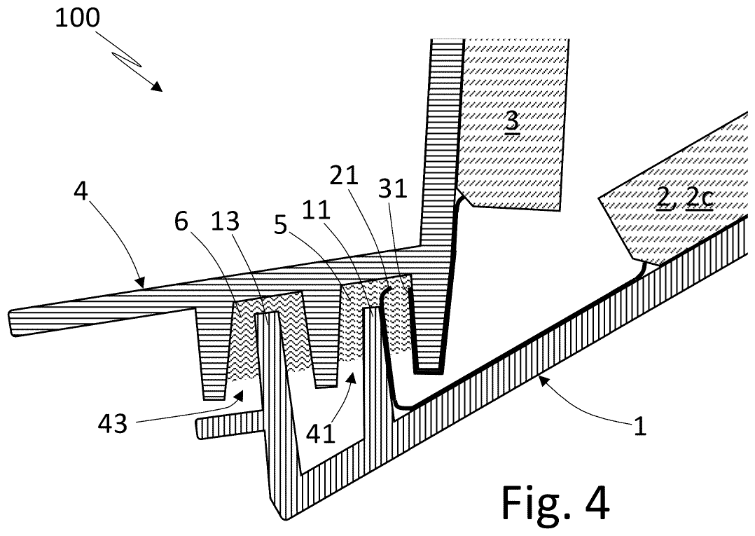

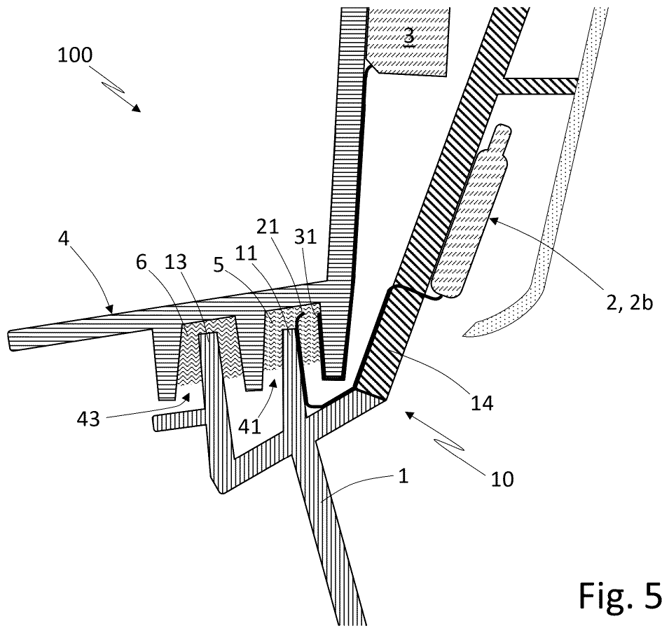

FIGS. 4 and 5 show parts of a fourth and fifth exemplary embodiment of the electrical unit 100 according to the invention in cross-sectional view, wherein the electrical module 2 is designed as a sensor element 2c and a light module 2b, respectively. In the exemplary embodiment of FIG. 5, the cover plate assembly 10 comprises the cover plate 1 and the cover frame 14 joined to it, on which the electrical module 2 is arranged.

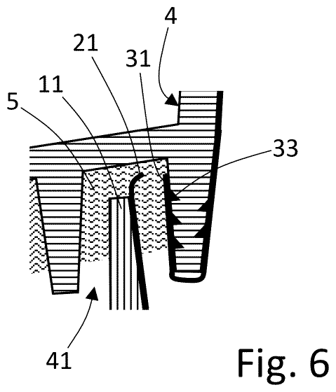

FIG. 6 shows a cross-sectional detailed view around the pocket 41 of a unit according to the invention, wherein the electrical contact means 31, which connects the control unit to the electrical contact means 11 of the electrical module via the electrically conductive joining means 5, is latched to the pocket 41. For this purpose, the electrical contact means 31 has the barb-like latching lugs 33, which are accommodated in associated recesses on the housing 4. Latching the contact means 31 in this manner is particularly advantageous for safe handling during installation of the unit.

The invention is not limited to the above-mentioned embodiment. In fact, a number of variants are conceivable which make use of the solution described, even for fundamentally different designs. All features and/or advantages resulting from the claims, the description or the drawings, including design details, spatial arrangements and process steps, can be essential to the invention both individually and in various combinations.

### LIST OF REFERENCE NUMERALS

100 electrical unit
1 cover plate
10 cover plate assembly
11, 12 pin
13 joining web
14 cover frame
2 electrical module
2a heating module
2b light module
2c sensor module
21, 22 electrical contact means of the electrical module
21a, 22a metallic sleeve
3 control unit
31, 32 electrical contact means of the control unit
31a, 31b, 32a metallic insert
33 latching lug
4 housing
41, 42 pocket
43 joining bed
5 electrically conductive joining means
6 adhesive

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An electrical unit comprising:
a cover plate or a cover plate assembly;
an electrical module arranged on the cover plate or the cover plate assembly, wherein the electrical module is a heating module, a light module, or a sensor module, and wherein the electrical module is operable by a separate control unit; and
a housing having at least two pockets into which electrical contacts of the control unit enter, wherein the cover plate or the cover plate assembly has at least two pins on which electrical contacts of the electrical module are arranged, wherein the at least two pins project into the at least two pockets and are connected thereto by an electrically conductive joining means such that an electrical connection is formed between the electrical module and the control unit.

2. The electrical unit of claim 1, wherein the joining means is an electrically conductive adhesive or a solder.

3. The electrical unit of claim 1, wherein the electrical module is a heating module, the heating module comprising a heating foil.

4. The electrical unit of claim 1, wherein the electrical contacts of the electrical module or the electrical contacts of the control unit include line ends with exposed strands or contact lugs.

5. The electrical unit of claim 1, wherein the electrical contacts of the control unit are latched or clamped to the at least two pockets of the housing.

6. The electrical unit of claim 1, wherein:
the electrical contacts of the electrical module have metallic sleeves which are pushed onto the at least two pins of the cover plate or the cover plate assembly; or
the electrical contacts of the control unit have metallic inserts which are pressed onto the at least two pockets of the housing.

7. The electrical unit of claim 1, wherein the electrical contacts of the electrical module and the electrical contacts of the control unit are in direct physical contact, wherein the contact is secured by the joining means.

8. The electrical unit of claim 1, wherein the electrical module is arranged on a support frame or a cover frame, and wherein the support frame or the cover frame forms a part of the cover plate assembly.

9. The electrical unit of claim 1, wherein the electrical unit is a lighting device or a sensor device of a motor vehicle, and wherein the electrical module is a heating module for heating the cover plate.

10. A method comprising:
providing a cover plate or a cover plate assembly with an electrical module arranged thereon, wherein the cover plate or the cover plate assembly has at least two pins on which electrical contacts of the electrical module are arranged, and wherein the cover plate or the cover plate assembly has at least one joining web;
providing a control unit for operating the electrical module and providing a housing, the housing having a joining bed and at least two pockets into which electrical contacts of the control unit enter;
filling the at least two pockets of the housing with an electrically conductive joining means, wherein the electrical contacts of the control unit entering into the at least two pockets of the housing are covered with the joining means;
introducing an adhesive into the joining bed;
positioning the cover plate or the cover plate assembly on the housing such that the at least two pins of the cover plate or the cover plate assembly and the electrical contacts of the electrical module are immersed in the joining means in the at least two pockets, and such that the joining web is immersed in the adhesive in the joining bed; and
curing the joining means or the adhesive.
